(19) United States
(12) Patent Application Publication
(10) Pub. No.: US 2026/0353400 A1
(43) Pub. Date: Nov. 5, 2026

(54) INDICATION METHOD AND APPARATUS BASED ON TRANSMISSION CONFIGURATION INDICATION (TCI) STATE

(71) Applicant: Beijing Xiaomi Mobile Software Co., Ltd., Beijing (CN)

(72) Inventors: Gaoming DUAN, Beijing (CN); Liangang CHI, Beijing (CN)

(73) Assignee: Beijing Xiaomi Mobile Software Co., Ltd., Beijing (CN)

(21) Appl. No.: 19/124,711

(22) PCT Filed: Oct. 28, 2022
(86) PCT No.: PCT/CN2022/128418

§ 371 Date: Apr. 25, 2025

(51) Int. Cl. H04W 72/23; H04L 5/00

(52) U.S. Cl. CPC H04W 72/23; H04L 5/0098

(57) ABSTRACT

A method, apparatus, and computer-readable medium are disclosed for indicating a transmission configuration indication (TCI) state in a wireless communication system. The method performed by a terminal device includes receiving downlink control information (DCI) from a network device, where the DCI comprises a first information field for mapping an activated TCI state group and a second information field for indicating whether to enable one or more TCI states within the mapped group. The terminal may also receive a media access control control element (MAC CE) from the network device that specifies one or more activated TCI state groups and the TCI states included in each group. This enables flexible and efficient TCI state management to support advanced beamforming and mobility procedures in next-generation wireless networks.

### CROSS-REFERENCE TO RELATED APPLICATION

The application is a U.S. National Stage of International Application No. PCT/CN2022/128418 filed on Oct. 28, 2022, the entire content of which is incorporated herein by reference.

### TECHNICAL FIELD

The present application relates to the technical field of communication, and in particular, to a method and apparatus for indicating a transmission configuration indication (TCI) state.

### BACKGROUND

The Multiple Input Multiple Output (MIMO) technology has opened a new era for the development and utilization of spatial resources in mobile communication systems. Distributed MIMO is developed on the basis of traditional MIMO technology and expands the application scope of traditional MIMO. For terminals, distributed MIMO technology means that there will be multiple transmission and reception points (or Transmission/Receive Point, TRP) simultaneously providing services to the terminal, and there is no cell handover.

### SUMMARY

A first aspect of the present application provides a method for indicating a transmission configuration indication (TCI) state, which is performed by a terminal device and includes:
receiving downlink control information (DCI) sent by a network device, where the DCI includes a first information field and/or a second information field, the first information field is used to map a transmission configuration indication (TCI) state group activated by the terminal device, and the second information field is used to indicate whether to enable at least one TCI state included in the TCI state group corresponding to the first information field.

A second aspect of the present application provides a method for indicating a transmission configuration indication (TCI) state, which is performed by a network device and includes:
sending downlink control information (DCI) to a terminal device, where the DCI includes a first information field and/or a second information field, the first information field is used to map a transmission configuration indication (TCI) state group activated by the terminal device, and the second information field is used to indicate whether to enable at least one TCI state included in the TCI state group corresponding to the first information field.

A third aspect of the present application provides an apparatus for indicating a transmission configuration indication (TCI) state, the apparatus including:
a transceiving unit, configured to receive downlink control information (DCI) sent by a network device, where the DCI includes a first information field and/or a second information field, the first information field is used to map a transmission configuration indication (TCI) state group activated by the apparatus, and the second information field is used to indicate whether to enable at least one TCI state included in the TCI state group corresponding to the first information field.

A fourth aspect of the present application provides an apparatus for indicating a transmission configuration indication (TCI) state, the apparatus including:
a transceiving unit, configured to send downlink control information (DCI) to a terminal device, where the DCI includes a first information field and/or a second information field, the first information field is used to map a transmission configuration indication (TCI) state group activated by the terminal device, and the second information field is used to indicate whether to enable at least one TCI state included in the TCI state group corresponding to the first information field.

A fifth aspect embodiment of the present application provides a communication apparatus, which includes a processor and a memory, where the memory stores a computer program, and the processor executes the computer program stored in the memory to cause the apparatus to execute the method for indicating the transmission configuration indication (TCI) state as described in the embodiment of the above first aspect.

A sixth aspect embodiment of the present application provides a communication apparatus, which includes a processor and a memory, where the memory stores a computer program, and the processor executes the computer program stored in the memory to cause the apparatus to execute the method for indicating the transmission configuration indication (TCI) state as described in the embodiment of the above second aspect.

A seventh aspect embodiment of the present application provides a communication apparatus, which includes a processor and an interface circuit, where the interface circuit is configured to receive code instructions and transmit them to the processor, and the processor is configured to run the code instructions to enable the apparatus to execute the method for indicating the transmission configuration indication (TCI) state as described in the embodiment of the above first aspect.

An eighth aspect embodiment of the present application provides a communication apparatus, which includes a processor and an interface circuit, where the interface circuit is configured to receive code instructions and transmit them to the processor, and the processor is configured to run the code instructions to enable the apparatus to execute the method for indicating the transmission configuration indication (TCI) state as described in the embodiment of the above second aspect.

A ninth aspect embodiment of the present application provides a computer-readable storage medium configured to store instructions. When the instructions are executed, the method for indicating the transmission configuration indication (TCI) state as described in the embodiment of the above first aspect is implemented.

A tenth aspect embodiment of the present application provides a computer-readable storage medium configured to store instructions. When the instructions are executed, the method for indicating the transmission configuration indication (TCI) state as described in the embodiment of the above second aspect is implemented.

An eleventh embodiment of the present application provides a computer program, which, when executed on a computer, enables the computer to execute the method for indicating the transmission configuration indication (TCI) state as described in the embodiment of the above first aspect.

A twelfth aspect embodiment of the present application provides a computer program, which, when running on a computer, enables the computer to execute the method for indicating the transmission configuration indication (TCI) state as described in the embodiment of the above second aspect.

Additional aspects and advantages of the present application will be given in part in the description below, and in part will become apparent from the description below, or will be learned through the practice of the present application.

### BRIEF DESCRIPTION OF THE DRAWINGS

In order to illustrate the technical solutions of the embodiments of the present disclosure or the background in a clearer manner, the drawings that need to be used in the embodiments of the present disclosure or the background will be described in the following.

FIG. 1 is a schematic flow chart of a method for indicating a transmission configuration indication (TCI) state provided by an embodiment of the present application.

FIG. 2 is a schematic flow chart of a method for indicating a transmission configuration indication (TCI) state provided by an embodiment of the present application.

FIG. 3A is a schematic diagram of a MAC CE indicating activated TCI state groups according to an embodiment of the present application.

FIG. 3B is a schematic diagram of a DCI information field provided by an embodiment of the present application.

FIG. 4 is a schematic flow chart of a method for indicating a transmission configuration indication (TCI) state provided by an embodiment of the present application.

FIG. 5 is a schematic flow chart of a method for indicating a transmission configuration indication (TCI) state provided by an embodiment of the present application.

FIG. 6 is a schematic diagram of a structure of an apparatus for indicating a transmission configuration indication (TCI) state provided by an embodiment of the present application.

FIG. 7 is a schematic diagram of a structure of an apparatus for indicating a transmission configuration indication (TCI) state provided by an embodiment of the present application.

FIG. 8 is a schematic diagram of a structure of another apparatus for indicating a transmission configuration indication (TCI) state provided by an embodiment of the present application.

FIG. 9 is a schematic diagram of a structure of a chip provided by an embodiment of the present application.

### DETAILED DESCRIPTION

For ease of understanding, terms involved in the present application are firstly introduced.

Transmission and Reception Point (TRP) or (Transmit/receive Point, TRP), corresponds to the service cell or neighboring cell of the terminal device. One cell contains one or more TRPs. One TRP contains one or more panels, and each panel contains one or more co-located antennas.
MIMO: Multiple Input Multiple Output;
PDCCH: Physical Downlink Control Channel;
PDSCH: Physical Downlink Shared Channel;
PUCCH: Physical Uplink Control Channel;
PUSCH: Physical Uplink Shared Channel;
DL: downlink;
UL: uplink;
TCI: Transmission Configuration Indication;
DCI: Downlink Control Information;
RRC: Radio Resource Control;
CSI-RS: Channel State Information Reference Signal;
DMRS: Demodulation Reference Signal;
MAC CE: Medium Access Control Control Element (or control unit);
CJT: Coherent Joint Transmission;
BWP: Bandwidth Part;
CC: Component Carrier;
CQI: Channel Quality Indication; and
PMI: Precoding Matrix Indicator.

Exemplary embodiments will be described in detail herein, examples of which are illustrated in the accompanying drawings. The following description refers to the accompanying drawings in which the same numbers in different drawings represent the same or similar elements unless otherwise represented. The implementations set forth in the following description of illustrative embodiments do not represent all implementations consistent with embodiments of the present disclosure. Instead, they are merely examples of apparatuses and methods consistent with some aspects related to embodiments of the present disclosure as recited in the appended claims.

Terms used herein in embodiments of the present application are only for the purpose of describing specific embodiments, but should not be construed to limit the present disclosure. As used in the embodiments of the present application and the appended claims, “a/an”, “said” and “the” in singular forms are intended to include plural forms, unless clearly indicated in the context otherwise. It should also be understood that, the term “and/or” used herein represents and contains any or all possible combinations of one or more associated listed items.

It should be understood that although the terms first, second, third, etc. may be used to describe various information in the present disclosure, such information should not be limited to these terms. These terms are only used to distinguish the same type of information from each other. For example, without departing from the scope of the embodiments of the present disclosure, the first information may also be referred to as the second information, and similarly, the second information may also be referred to as the first information. Depending on the context, the word “if” and “in case” as used herein may be interpreted as “when . . . ” or “upon . . . ” or “in response to determination”.

The embodiments of the present application are described in detail below, and examples of the embodiments are shown in the accompanying drawings, in which the same or similar reference numerals throughout represent the same or similar elements. The embodiments described below with reference to the accompanying drawings are exemplary and are intended to be used to explain the present application, and should not be construed as limiting the present application.

It should be noted that the technical solutions of the embodiments of the present application can be applied to various communication systems, such as Long Term Evolution (LTE) system, the fifth-generation mobile communication system, 5G new air interface system, or other future new mobile communication systems, etc.

The network device in the embodiments of the present application is an entity on the network side for transmitting or receiving signals. For example, the network device may be an evolved NodeB (eNB), a transmission reception point (TRP), a next generation NodeB (gNB) in the NR system, a base station in other future mobile communication systems or an access point in a wireless fidelity (WiFi) system, etc. In the embodiments of the present application, a specific technology and a specific device form that are adopted by the network device are not limited. The network device provided in the embodiments of the present application may be composed of a central unit (CU) and a distributed unit (DU), and the CU may also be referred to as a control unit, the protocol layer of the network side device, such as a base station, can be split by adopting a CU-DU structure, parts of functions of the protocol layer are centrally controlled by the CU, and parts or all of remaining functions of the protocol layer are distributed in the DU, and the DU is centrally controlled by the CU.

The terminal device in the embodiment of the present application is an entity on the user side for receiving or transmitting signals, such as a mobile phone. The terminal device may also be referred to as a terminal, user equipment (UE), a mobile station (MS), a mobile terminal (MT), etc. The terminal device may be a car with a communication function, a smart car, a mobile phone, a wearable device, a tablet computer (Pad), a computer with a radio transceiver function, a virtual reality (VR) terminal device, an augmented reality (AR) terminal device, a radio terminal device in industrial control, a radio terminal in self-driving, a radio terminal device in remote medical surgery, a radio terminal in a smart grid, a radio terminal device in transportation safety, a radio terminal device in a smart city, a radio terminal device in a smart home, etc. In the embodiments of the present application, a specific technology and a specific device form that are adopted by the terminal device are not limited.

In the above communication system, the distributed MIMO technology may be used, and multiple TRPs (Multi-TRP) may be used simultaneously to provide services to the terminal. For the terminal, there is no cell switching. Without the concept of cell boundaries, the user experience will be smoother. In addition, multiple TRPs serve one terminal device, and the signal quality is better guaranteed, which can meet the high-rate and high-capacity service requirements of the terminal device.

Since different TRPs are located at different positions in space, the large-scale fading corresponding to each TRP is significantly different. In the related art, when multiple TRPs jointly perform transmission, it is necessary to indicate the corresponding beam information of different TRPs respectively. The downlink beam information is indicated by the TCI state. In the related art, the Radio Resources Control (RRC) may configure 128 TCI states for the terminal device, and then the Medium Access Control Control Element (MAC CE) activates at most 8 TCI state groups among them, each of which includes at most two TCI states.

However, in the future, with the increasing maturity of distributed MIMO technology, the number of TRPs in joint transmission will increase, and as the communication frequency increases, the density of network deployment will also increase. The TRP or its corresponding beam serving the terminal may be switched frequently. How to support such frequent switching is a problem that needs to be solved.

The method for indicating the transmission configuration indication (TCI) state and apparatus thereof provided in the present application are described in detail below with reference to the accompanying drawings.

Reference is made to FIG. 1, which is a schematic flow chart of a method for indicating a transmission configuration indication (TCI) state provided by an embodiment of the present application. It should be noted that the method for indicating the transmission configuration indication (TCI) state in the embodiment of the present application is performed by a terminal device. As shown in FIG. 1, the method may include the following steps.

In step 101, DCI sent by a network device is received, where the DCI includes a first information field and/or a second information field, the first information field is used to map a TCI state group activated by the terminal device, and the second information field is used to indicate whether to enable at least one TCI state included in the TCI state group corresponding to the first information field.

In the embodiment of the present application, the terminal device is capable of receiving the downlink control information (DCI) sent by the network device, the DCI including the first information field and/or the second information field, where the first information field is used to map the TCI state group activated by the terminal device, and the second information field is used to indicate at least one TCI state in the TCI state group corresponding to the first information field.

It should be noted that in the embodiment of the present application, the enabled TCI state corresponding to the DCI is used for downlink transmission of the terminal device.

In some implementations, the terminal device is capable of receiving a first signaling sent by the network device, where the first signaling is used to indicate to the terminal device whether the DCI includes the second information field.

It can be understood that, as a possible manner, the DCI does not include the second information field, and the TCI state group corresponding to the first information field of the DCI includes at least one TCI state, which is all used for downlink transmission of the terminal device.

In another possible manner, the DCI includes a second information field, and the second information field indicates at least one enabled TCI state in the TCI state group corresponding to the first information field of the DCI for downlink transmission of the terminal device.

In some implementations, the terminal device may receive a Medium Access Control Control Element (MAC CE) sent by the network device, where the MAC CE is used to indicate at least one TCI state group activated by the terminal device and at least one TCI state included in each TCI state group.

It can be understood that the number of the TCI state included in each TCI state group may be the same or different.

In some implementations, the first information field includes a plurality of code points, and each code point corresponds to a TCI state group indicated by the MAC CE.

At least one code point included in the first information field means that, for example, if the first information field has 3 bits, the first information field includes 8 code points, namely 000, 001, 010, 011, 100, 101, 110, and 111 respectively. Each code point may correspond to one TCI state group indicated by the MAC CE.

It can be understood that the TCI state group corresponding to the first information field refers to the TCI state group corresponding to the current code point of the first information field.

In some implementations, the number of code points included in the first information field is the same as a maximum number of TCI state groups activated as indicated by the MAC CE.

In an embodiment of the present application, the second information field includes at least one first indication information, and the first indication information is used to indicate whether a TCI state corresponding to the first indication information is enabled.

That is, each first indication information included in the second information field corresponds to one TCI state in the TCI state group corresponding to the first information field, and each first indication information may indicate that the TCI state corresponding thereto is enabled.

Optionally, each first indication information is 1-bit information, which is used to indicate whether the TCI state corresponding to the first indication information is enabled.

In some implementations, the number of first indication information included in the second information field is the same as a maximum number of the TCI states included in the TCI state group.

In some implementations, the first information field and/or the second information field may occupy an information field reserved in the DCI or may occupy an information field newly added to the DCI. It can be understood that the first information field may occupy the information field reserved in the DCI, and the second information field may occupy the information field newly added in the DCI; the first information field may occupy the information field newly added in the DCI, and the second information field may occupy the information field reserved in the DCI; the first information field and the second information field may both occupy the information field reserved in the DCI, or the first information field and the second information field may both occupy the information field newly added in the DCI, and so on.

In summary, by receiving the downlink control information (DCI) sent by the network device, where the DCI includes the first information field and/or the second information field, the first information field is used to map the transmission configuration indication (TCI) state group activated by the terminal device, and the second information field is used to indicate whether to enable at least one TCI state included in the TCI state group corresponding to the first information field, the DCI can support the mapping of more TCI states, and at the same time can support faster switching of TRP and TCI state indications, thereby further enabling the terminal device to ensure the reliability of connection and service in frequent switching, and effectively improve the communication efficiency of the system.

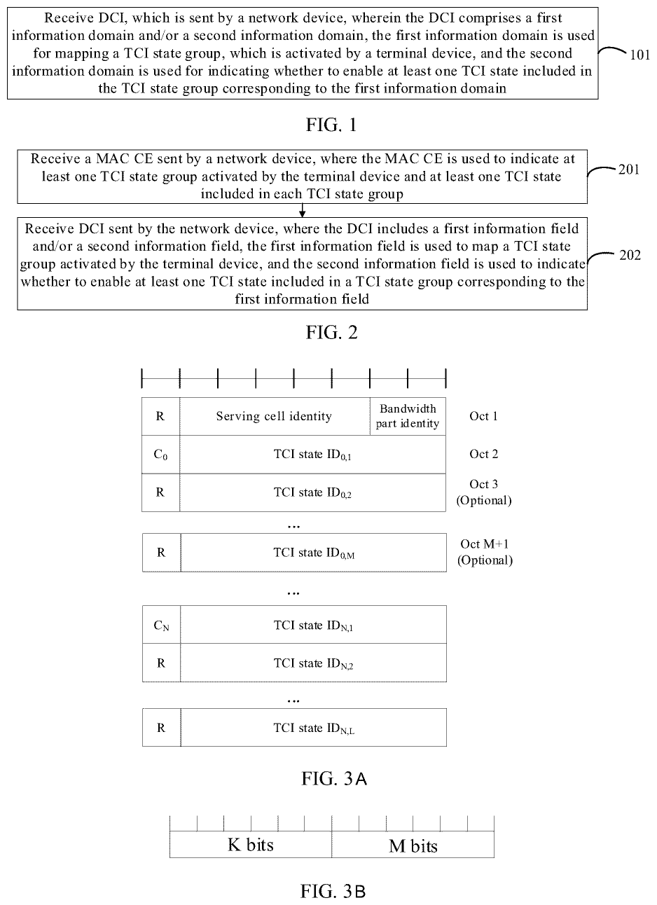

Reference is made to FIG. 2, which is a schematic flow chart of a method for indicating a transmission configuration indication (TCI) state provided by an embodiment of the present application. It should be noted that the method for indicating the transmission configuration indication (TCI) state in the embodiment of the present application is performed by a terminal device. As shown in FIG. 2, the method may include the following steps.

In step 201, a MAC CE sent by a network device is received, where the MAC CE is used to indicate at least one TCI state group activated by the terminal device and at least one TCI state included in each TCI state group.

In the embodiment of the present application, the terminal device is capable of receiving the MAC CE sent by the network device, where the MAC CE is used to indicate at least one TCI state group activated by the terminal device and at least one TCI state included in each TCI state group.

Optionally, the network device may configure multiple TCI states for the terminal device through RRC, and the MAC CE is used to indicate at least one TCI state group activated among the configured multiple TCI states and at least one TCI state included in each TCI state group.

As an example, the MAC CE indicates at least one TCI state group activated, and at least one TCI state included in each TCI state group may be shown in FIG. 3A. In FIG. 3A, C₀ is a TCI state group activated by the terminal device, and the TCI state group includes M TCI states, namely TCI state ID_{0, 1}, TCI state ID_{0, 2} . . . TCI state ID_{0, M}. Similarly, C_{N} is a TCI state group activated by the terminal device, and the TCI state group includes L TCI states, namely TCI state ID_{0N, 1}, TCI state ID_{N, 2} . . . TCI state ID_{N, L}. M, L, N are all positive integers, and the values of M and L may be the same or different.

In the embodiment of the present application, each TCI state in the TCI state group is used for a different TRP.

In step 202, DCI sent by the network device is received, where the DCI includes a first information field and/or a second information field, the first information field is used to map a TCI state group activated by the terminal device, and the second information field is used to indicate whether to enable at least one TCI state included in a TCI state group corresponding to the first information field.

In the embodiment of the present application, the terminal device is capable of receiving the downlink control information (DCI) sent by the network device, where the DCI includes the first information field and/or the second information field, and where the first information field is used to map the TCI state group activated by the terminal device, and the second information field is used to indicate at least one TCI state in the TCI state group corresponding to the first information field.

It should be noted that in the embodiment of the present application, the enabled TCI state corresponding to the DCI is used for downlink transmission of the terminal device.

In some implementations, the terminal device is capable of receiving a first signaling sent by a network device, where the first signaling is used to indicate to the terminal device whether the DCI includes the second information field.

It can be understood that, as a possible manner, the DCI does not include the second information field, and the TCI state group corresponding to the first information field of the DCI includes at least one TCI state, which is all used for downlink transmission of the terminal device.

In another possible manner, the DCI includes a second information field, and the second information field indicates at least one enabled TCI state in the TCI state group corresponding to the first information field of the DCI for downlink transmission of the terminal device.

In an embodiment of the present application, each TCI state included in the TCI state group corresponding to the first information field corresponds to a different TRP, that is, each enabled TCI state is used for downlink transmission between a different TRP and the terminal device.

In an embodiment of the present application, the first information field includes a plurality of code points, and each code point corresponds to one TCI state group indicated by the MAC CE.

The at least one code point included in the first information field means that, for example, if the first information field has 3 bits, the first information field includes 8 code points, namely 000, 001, 010, 011, 100, 101, 110, and 111. Each code point may correspond to one TCI state group indicated by the MAC CE.

It can be understood that the TCI state group corresponding to the first information field refers to the TCI state group corresponding to the current code point of the first information field.

In some implementations, the number of code points included in the first information field is the same as the maximum number of TCI state groups activated as indicated by the MAC CE.

That is, for example, if the first information field has K bits, the first information field includes 2^{K} code points, and the MAC CE may indicate a maximum of 2^{K} activated TCI state groups. Each code point may be mapped to an activated TCI state group indicated by the MAC CE.

In an embodiment of the present application, the second information field includes at least one first indication information, and the first indication information is used to indicate whether the TCI state corresponding to the first indication information is enabled.

That is, each first indication information included in the second information field corresponds to one TCI state in the TCI state group corresponding to the first information field, and each first indication information may indicate that the TCI state corresponding thereto is enabled.

Optionally, each first indication information is 1-bit information, which is used to indicate whether the TCI state corresponding to the first indication information is enabled.

Optionally, when the first indication information is set to “0”, it indicates that the TCI state corresponding to the first indication information is not enabled, and when the first indication information is set to “1”, it indicates that the TCI state corresponding to the first indication information is enabled. Alternatively, when the first indication information is set to “0”, it indicates that the TCI state corresponding to the first indication information is enabled, and when the first indication information is set to “1”, it indicates that the TCI state corresponding to the first indication information is not enabled.

In some implementations, the number of first indication information included in the second information field is the same as a maximum number of the TCI states included in the TCI state group.

That is, for example, the second information field has M bits, and each activated TCI state group indicated by the MAC CE includes at most M TCI states. The M bits are M first indication information, each of which is 1 bit, and is used to indicate whether the TCI state corresponding to the first indication information is enabled.

Optionally, the principle of sequential indication may be adopted, that is, the first piece of the first indication information (the first bit) in the second information field corresponds to the first TCI state in the TCI state group corresponding to the first information field.

Optionally, when the first indication information is set to “0”, it indicates that the TCI state corresponding to the first indication information is not enabled, and when the first indication information is set to “1”, it indicates that the TCI state corresponding to the first indication information is enabled. Alternatively, when the first indication information is set to “0”, it indicates that the TCI state corresponding to the first indication information is enabled, and when the first indication information is set to “1”, it indicates that the TCI state corresponding to the first indication information is not enabled.

Optionally, if the TCI state group corresponding to the first information field includes L TCI states, and L<M, the first L bits or the last L bits in the second information field may be used to indicate whether the L TCI states are enabled, and the remaining M−L+1 bits of the second information field that are not used as the first indication information may all be set to “0” or set to “1”.

As an example, the first information field and the second information field of the DCI may be as shown in FIG. 3B. The first information field has K bits, and the second information field has M bits. The terminal device may receive the first signaling sent by the network device, and the first signaling may indicate whether the DCI includes the second information field. If the first information field has K bits, the first information field includes 2^{K} code points, and the MAC CE may indicate at most 2^{K} activated TCI state groups. Each code point may be mapped to an activated TCI state group indicated by the MAC CE. The second information field has M bits, and each activated TCI state group indicated by the MAC CE includes at most M TCI states. The M bits are M first indication information, and each first indication information is 1 bit, which is used to indicate whether the TCI state corresponding to the first indication information is enabled.

It should be noted that in the embodiments of the present application, K, L, and M are all positive integers.

In some implementations, the first information field and/or the second information field may occupy an information field reserved in the DCI or may occupy an information field newly added to the DCI. It can be understood that the first information field may occupy the information field reserved in the DCI, and the second information field may occupy the information field newly added in the DCI; the first information field may occupy the information field newly added in the DCI, and the second information field may occupy the information field reserved in the DCI; the first information field and the second information field may both occupy the information field reserved in the DCI, or the first information field and the second information field may both occupy the information field newly added in the DCI, and so on.

As an example, K bits of the first information field and/or the M bits of the second information field may occupy the bits reserved in the DCI, or may occupy the bits newly added in the DCI. For example, the K bits of the first information field may occupy the bits reserved in the DCI, and the M bits of the second information field may occupy the bits newly added in the DCI; the K bits of the first information field may occupy the bits newly added in the DCI, and the M bits of the second information field may occupy the bits reserved in the DCI; the K bits of the first information field and the M bits of the second information field may both occupy the bits reserved in the DCI, or the K bits of the first information field and the M bits of the second information field may both occupy the bits newly added in the DCI.

In summary, by receiving the MAC CE sent by the network device, where the MAC CE is used to indicate at least one TCI state group activated by the terminal device and at least one TCI state included in each TCI state group, and receiving the DCI sent by the network device, where the DCI includes the first information field and/or the second information field, the first information field is used to map the TCI state group activated by the terminal device, and the second information field is used to indicate whether to enable at least one TCI state included in the TCI state group corresponding to the first information field, the DCI can support the mapping of more TCI states, and at the same time can support faster switching of TRP and TCI state indications, thereby further enabling the terminal device to ensure the reliability of connection and service in frequent switching, and effectively improve the communication efficiency of the system.

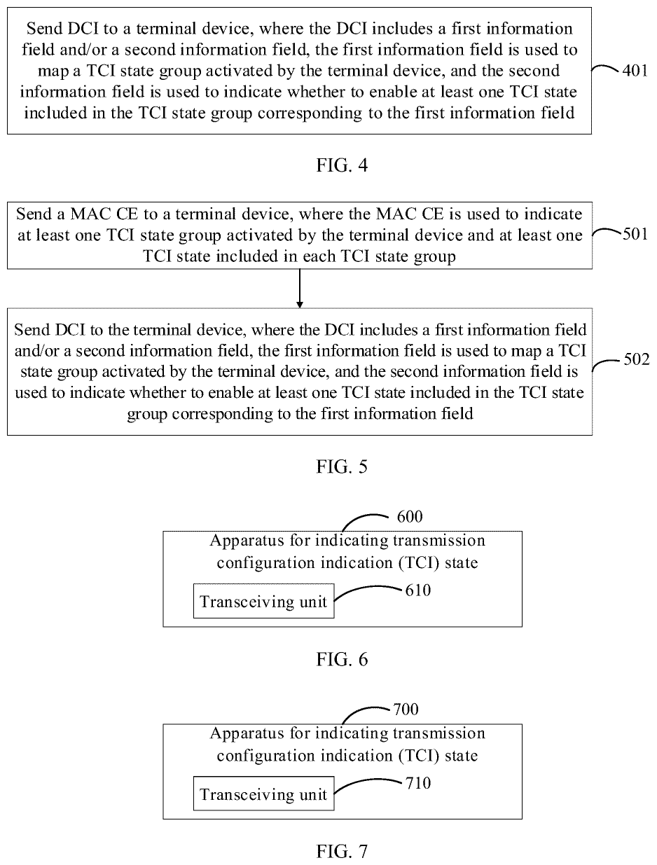

Reference is made FIG. 4, which is a schematic flow chart of a method for indicating a transmission configuration indication (TCI) state provided by an embodiment of the present application. It should be noted that the method for indicating the transmission configuration indication (TCI) state in the embodiment of the present application is performed by a network device. As shown in FIG. 4, the method may include the following steps.

In step 401, DCI is sent to a terminal device, where the DCI includes a first information field and/or a second information field, the first information field is used to map a TCI state group activated by the terminal device, and the second information field is used to indicate whether to enable at least one TCI state included in the TCI state group corresponding to the first information field.

In the embodiment of the present application, the network device is capable of sending the downlink control information (DCI) to the terminal device, the DCI including the first information field and/or the second information field, where the first information field is used to map the TCI state group activated by the terminal device, and the second information field is used to indicate at least one TCI state in the TCI state group corresponding to the first information field.

It should be noted that in the embodiment of the present application, the enabled TCI state corresponding to the DCI is used for downlink transmission of the terminal device.

In some implementations, the network device is capable of sending a first signaling to the terminal device, where the first signaling is used to indicate to the terminal device whether the DCI includes the second information field.

It can be understood that, as a possible manner, the DCI does not include the second information field, and the TCI state group corresponding to the first information field of the DCI includes at least one TCI state, which is all used for downlink transmission of the terminal device.

In another possible manner, the DCI includes a second information field, and the second information field indicates at least one enabled TCI state in the TCI state group corresponding to the first information field of the DCI for downlink transmission of the terminal device.

In some implementations, the network device may send a media access control control element (MAC CE) to the terminal device, where the MAC CE is used to indicate at least one TCI state group activated by the terminal device and at least one TCI state included in each TCI state group.

It can be understood that the number of the TCI state included in each TCI state group can be the same or different.

In some implementations, the first information field includes a plurality of code points, and each code point corresponds to a TCI state group indicated by the MAC CE.

The at least one code point included in the first information field means that, for example, if the first information field has 3 bits, the first information field includes 8 code points, namely 000, 001, 010, 011, 100, 101, 110, and 111 respectively. Each code point may correspond to one TCI state group indicated by the MAC CE.

It can be understood that the TCI state group corresponding to the first information field refers to the TCI state group corresponding to the current code point of the first information field.

In some implementations, the number of code points included in the first information field is the same as the maximum number of TCI state groups activated as indicated by the MAC CE.

In an embodiment of the present application, the second information field includes at least one first indication information, and the first indication information is used to indicate whether a TCI state corresponding to the first indication information is enabled.

That is, each first indication information included in the second information field corresponds to one TCI state in the TCI state group corresponding to the first information field, and each first indication information may indicate that the TCI state corresponding thereto is enabled.

Optionally, each first indication information is 1-bit information, which is used to indicate whether the TCI state corresponding to the first indication information is enabled.

In some implementations, the number of first indication information included in the second information field is the same as a maximum number of the TCI states included in the TCI state group.

In some implementations, the first information field and/or the second information field may occupy an information field reserved in the DCI or may occupy an information field newly added to the DCI. It can be understood that the first information field may occupy the information field reserved in the DCI, and the second information field may occupy the information field newly added in the DCI; the first information field may occupy the information field newly added in the DCI, and the second information field may occupy the information field reserved in the DCI; the first information field and the second information field may both occupy the information field reserved in the DCI, or the first information field and the second information field may both occupy the information field newly added in the DCI, and so on.

In summary, by sending DCI to the terminal device, where the DCI includes the first information field and/or the second information field, the first information field is used to map the TCI state group activated by the terminal device, and the second information field is used to indicate whether to enable at least one TCI state included in the TCI state group corresponding to the first information field, the DCI can support the mapping of more TCI states and at the same time support faster switching of TRP and TCI state indications, thereby further enabling the terminal device to ensure the reliability of connection and service in frequent switching, and effectively improving the communication efficiency of the system.

Reference is made to FIG. 5, which is a schematic flow chart of a method for indicating a transmission configuration indication (TCI) state provided in an embodiment of the present application. It should be noted that the method for indicating the transmission configuration indication (TCI) state in the embodiment of the present application is performed by a network device. As shown in FIG. 5, the method may include the following steps.

In step 501, a MAC CE is sent to a terminal device, where the MAC CE is used to indicate at least one TCI state group activated by the terminal device and at least one TCI state included in each TCI state group.

In the embodiment of the present application, the network device can send the MAC CE to the terminal device, where the MAC CE is used to indicate at least one TCI state group activated by the terminal device and at least one TCI state included in each TCI state group.

Optionally, the network device may configure multiple TCI states for the terminal device through RRC, and the MAC CE is used to indicate at least one TCI state group activated among the configured multiple TCI states and at least one TCI state included in each TCI state group.

As an example, the MAC CE indicates at least one TCI state group activated, and at least one TCI state included in each TCI state group may be shown in FIG. 3A. In FIG. 3A, C₀ is a TCI state group activated by the terminal device, and the TCI state group includes M TCI states, namely TCI state ID_{0, 1}, TCI state ID_{0, 2} . . . TCI state ID_{0, M}. Similarly, C_{N} is a TCI state group activated by the terminal device, and the TCI state group includes L TCI states, namely TCI state ID_{0N, 1}, TCI state ID_{N, 2} . . . TCI state ID_{N, L}. M, L, N are all positive integers, and the values of M and L may be the same or different.

In the embodiment of the present application, each TCI state in the TCI state group is used for a different TRP.

In step 502, DCI is sent to the terminal device, where the DCI includes a first information field and/or a second information field, the first information field is used to map a TCI state group activated by the terminal device, and the second information field is used to indicate whether to enable at least one TCI state included in the TCI state group corresponding to the first information field.

In the embodiment of the present application, the network device is capable of sending the DCI to the terminal device, where the DCI includes the first information field and/or the second information field, and where the first information field is used to map the TCI state group activated by the terminal device, and the second information field is used to indicate at least one TCI state in the TCI state group corresponding to the first information field.

It should be noted that in the embodiment of the present application, the enabled TCI state corresponding to the DCI is used for downlink transmission of the terminal device.

In some implementations, the network device can send a first signal to the terminal device and instruct the terminal device through the first signal whether the DCI includes the second information field.

It can be understood that, as a possible manner, the DCI does not include the second information field, and the TCI state group corresponding to the first information field of the DCI includes at least one TCI state, which is all used for downlink transmission of the terminal device.

In another possible manner, the DCI includes a second information field, and the second information field indicates at least one enabled TCI state in the TCI state group corresponding to the first information field of the DCI for downlink transmission of the terminal device.

In an embodiment of the present application, each TCI state included in the TCI state group corresponding to the first information field corresponds to a different TRP, that is, each enabled TCI state is used for downlink transmission between a different TRP and the terminal device.

In an embodiment of the present application, the first information field includes a plurality of code points, and each code point corresponds to one TCI state group indicated by the MAC CE.

The at least one code point included in the first information field means that, for example, if the first information field has 3 bits, the first information field includes 8 code points, namely 000, 001, 010, 011, 100, 101, 110, and 111. Each code point may correspond to one TCI state group indicated by the MAC CE.

It can be understood that the TCI state group corresponding to the first information field refers to the TCI state group corresponding to the current code point of the first information field.

In some implementations, the number of code points included in the first information field is the same as the maximum number of TCI state groups activated as indicated by the MAC CE.

That is, for example, if the first information field has K bits, the first information field includes 2^{K} code points, and the MAC CE may indicate a maximum of 2^{K} activated TCI state groups. Each code point may be mapped to an activated TCI state group indicated by the MAC CE.

In an embodiment of the present application, the second information field includes at least one first indication information, and the first indication information is used to indicate whether the TCI state corresponding to the first indication information is enabled.

That is, each first indication information included in the second information field corresponds to one TCI state in the TCI state group corresponding to the first information field, and each first indication information may indicate that the TCI state corresponding thereto is enabled.

Optionally, each first indication information is 1-bit information, which is used to indicate whether the TCI state corresponding to the first indication information is enabled.

Optionally, when the first indication information is set to “0”, it indicates that the TCI state corresponding to the first indication information is not enabled, and when the first indication information is set to “1”, it indicates that the TCI state corresponding to the first indication information is enabled. Alternatively, when the first indication information is set to “0”, it indicates that the TCI state corresponding to the first indication information is enabled, and when the first indication information is set to “1”, it indicates that the TCI state corresponding to the first indication information is not enabled.

In some implementations, the number of first indication information included in the second information field is the same as a maximum number of the TCI states included in the TCI state group.

That is, for example, the second information field has M bits, and each activated TCI state group indicated by the MAC CE includes at most M TCI states. The M bits are M first indication information, each of which is 1 bit, and is used to indicate whether the TCI state corresponding to the first indication information is enabled.

Optionally, the principle of sequential indication may be adopted, that is, the first piece of the first indication information (the first bit) in the second information field corresponds to the first TCI state in the TCI state group corresponding to the first information field.

Optionally, when the first indication information is set to “0”, it indicates that the TCI state corresponding to the first indication information is not enabled, and when the first indication information is set to “1”, it indicates that the TCI state corresponding to the first indication information is enabled. Alternatively, when the first indication information is set to “0”, it indicates that the TCI state corresponding to the first indication information is enabled, and when the first indication information is set to “1”, it indicates that the TCI state corresponding to the first indication information is not enabled.

Optionally, if the TCI state group corresponding to the first information field includes L TCI states, and L<M, the first L bits or the last L bits in the second information field may be used to indicate whether the L TCI states are enabled, and the remaining M−L+1 bits of the second information field that are not used as the first indication information may all be set to “0” or set to “1”.

As an example, the first information field and the second information field of the DCI may be as shown in FIG. 3B. The first information field has K bits, and the second information field has M bits. The terminal device may receive the first signaling sent by the network device, and the first signaling may indicate whether the DCI includes the second information field. If the first information field has K bits, the first information field includes 2^{K} code points, and the MAC CE may indicate at most 2^{K} activated TCI state groups. Each code point may be mapped to an activated TCI state group indicated by the MAC CE. The second information field has M bits, and each activated TCI state group indicated by the MAC CE includes at most M TCI states. The M bits are M first indication information, and each first indication information is 1 bit, which is used to indicate whether the TCI state corresponding to the first indication information is enabled.

It should be noted that in the embodiments of the present application, K, L, and M are all positive integers.

In some implementations, the first information field and/or the second information field may occupy an information field reserved in the DCI or may occupy an information field newly added to the DCI. It can be understood that the first information field may occupy the information field reserved in the DCI, and the second information field may occupy the information field newly added in the DCI; the first information field may occupy the information field newly added in the DCI, and the second information field may occupy the information field reserved in the DCI; the first information field and the second information field may both occupy the information field reserved in the DCI, or the first information field and the second information field may both occupy the information field newly added in the DCI, and so on.

As an example, K bits of the first information field and/or the M bits of the second information field may occupy the bits reserved in the DCI, or may occupy the bits newly added in the DCI. For example, the K bits of the first information field may occupy the bits reserved in the DCI, and the M bits of the second information field may occupy the bits newly added in the DCI; the K bits of the first information field may occupy the bits newly added in the DCI, and the M bits of the second information field may occupy the bits reserved in the DCI; the K bits of the first information field and the M bits of the second information field may both occupy the bits reserved in the DCI, or the K bits of the first information field and the M bits of the second information field may both occupy the bits newly added in the DCI.

In summary, by sending the MAC CE to the terminal device, where the MAC CE is used to indicate at least one TCI state group activated by the terminal device and at least one TCI state included in each TCI state group, and sending the DCI to the terminal device, where the DCI includes the first information field and/or the second information field, the first information field is used to map the TCI state group activated by the terminal device, and the second information field is used to indicate whether to enable at least one TCI state included in the TCI state group corresponding to the first information field, the DCI can support the mapping of more TCI states, and at the same time can support faster switching of TRP and TCI state indications, thereby further enabling the terminal device to ensure the reliability of connection and service in frequent switching, and effectively improve the communication efficiency of the system.

Corresponding to the method for indicating the transmission configuration indication (TCI) state provided by the above several embodiments, the present application further provides an apparatus for indicating a transmission configuration indication (TCI) state. Since the apparatus for indicating the transmission configuration indication (TCI) state provided by the embodiments of the present application corresponds to the methods provided in the above several embodiments, the implementation manners of the method for indicating the transmission configuration indication (TCI) state is also applicable to the apparatus for indicating the transmission configuration indication (TCI) state provided in the following embodiments, and will not be described in detail in the following embodiments.

Reference is made to FIG. 6, which is a schematic diagram of a structure of an apparatus for indicating a transmission configuration indication (TCI) state provided by an embodiment of the present application.

As shown in FIG. 6, the apparatus 600 for indicating the transmission configuration indication (TCI) state includes: a transceiving unit 610.

The transceiving unit 610 is configured to receive downlink control information (DCI) sent by a network device, where the DCI includes a first information field and/or a second information field, the first information field is used to map a transmission configuration indication (TCI) state group activated by the apparatus, and the second information field is used to indicate whether to enable at least one TCI state included in the TCI state group corresponding to the first information field.

Optionally, the transceiving unit 610 is further configured to: receive a media access control control element (MAC CE) sent by the network device, where the MAC CE is used to indicate at least one TCI state group activated by the terminal device and at least one TCI state included in each TCI state group.

Optionally, the first information field includes a plurality of code points, and each code point corresponds to one TCI state group indicated by the MAC CE.

Optionally, the number of code points included in the first information field is the same as a maximum number of TCI state groups activated as indicated by the MAC CE.

Optionally, the second information field includes at least one first indication information, and the first indication information is used to indicate whether the TCI state corresponding to the first indication information is enabled.

Optionally, the number of first indication information included in the second information field is the same as a maximum number of TCI states included in the TCI state group.

Optionally, the transceiving unit 610 is further configured to receive the first signal sent by the network device, where the first signal is used to indicate whether the DCI includes the second information field.

Optionally, the first information field and/or the second information field occupies a reserved information field of the DCI; or, the first information field and/or the second information field occupies a newly added information field of the DCI.

The apparatus for indicating the transmission configuration indication (TCI) state of this embodiment may receive the DCI sent by the network device, where the DCI includes the first information field and/or the second information field, the first information field is used to map the TCI state group activated by the terminal device, and the second information field is used to indicate whether to enable at least one TCI state included in the TCI state group corresponding to the first information field, so that the DCI can support the mapping of more TCI states and support faster switching of TRP and TCI state indications, thereby further enabling the terminal device to ensure the reliability of connection and service in frequent switching, and effectively improve the communication efficiency of the system.

Reference is made to FIG. 7, which is a schematic diagram of a structure of an apparatus for indicating a transmission configuration indication (TCI) state provided by an embodiment of the present application.

As shown in FIG. 7, the apparatus 700 for indicating the transmission configuration indication (TCI) state includes: a transceiving unit 710.

The transceiving unit 710 sends downlink control information (DCI) to the terminal device, where the DCI includes a first information field and/or a second information field, the first information field is used to map a transmission configuration indication (TCI) state group activated by the terminal device, and the second information field is used to indicate whether to enable at least one TCI state included in the TCI state group corresponding to the first information field.

Optionally, the transceiving unit 710 is further configured to: send a media access control control element (MAC CE) to the terminal device, where the MAC CE is used to indicate at least one TCI state group activated by the terminal device and at least one TCI state included in each TCI state group.

Optionally, the first information field includes a plurality of code points, and each code point corresponds to one TCI state group indicated by the MAC CE.

Optionally, the number of code points included in the first information field is the same as a maximum number of TCI state groups activated as indicated by the MAC CE.

Optionally, the second information field includes at least one first indication information, and the first indication information is used to indicate whether the TCI state corresponding to the first indication information is enabled.

Optionally, the number of first indication information included in the second information field is the same as a maximum number of the TCI states included in the TCI state group.

Optionally, the transceiving unit 710 is further configured to send a first signal to the terminal device, where the first signaling is used to indicate whether the DCI includes the second information field.

Optionally, the first information field and/or the second information field occupies a reserved information field of the DCI; or, the first information field and/or the second information field occupies a newly added information field of the DCI.

The apparatus for indicating the transmission configuration indication (TCI) state of this embodiment may send the DCI to the terminal device, and the DCI includes the first information field and/or the second information field, where first information field is used to map the TCI state group activated by the terminal device, and the second information field is used to indicate whether to enable at least one TCI state included in the TCI state group corresponding to the first information field, so that the DCI can support the mapping of more TCI states and support faster switching of TRP and TCI state indications, thereby further enabling the terminal device to ensure the reliability of connection and service in frequent switching, and effectively improve the communication efficiency of the system.

In order to implement the above embodiments, an embodiment of the present application further proposes a communication apparatus, including: a processor and a memory, where the memory stores a computer program, and the processor executes the computer program stored in the memory to cause the apparatus to execute the method shown in the embodiments of FIGS. 1 to 2.

In order to implement the above embodiments, an embodiment of the present application further proposes a communication apparatus, including: a processor and a memory, where the memory stores a computer program, and the processor executes the computer program stored in the memory to cause the apparatus to execute the method shown in the embodiments of FIGS. 4 to 5.

In order to implement the above embodiments, an embodiment of the present application further proposes a communication apparatus, including: a processor and an interface circuit, where the interface circuit is configured to receive code instructions and transmit them to the processor, and the processor is configured to run the code instructions to execute the method shown in the embodiments of FIGS. 1 to 2.

In order to implement the above embodiments, an embodiment of the present application further proposes a communication apparatus, including: a processor and an interface circuit, where the interface circuit is configured to receive code instructions and transmit them to the processor, and the processor is configured to run the code instructions to execute the method shown in the embodiments of FIGS. 4 to 5.

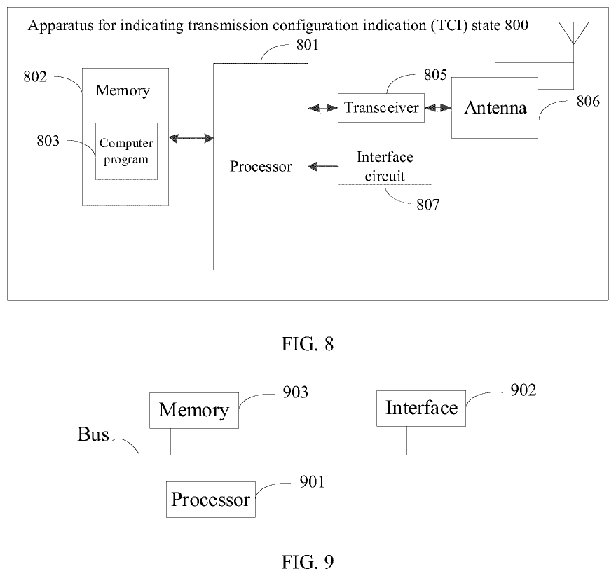

Reference is made to FIG. 8, which is a schematic diagram of a structure of another apparatus for indicating a transmission configuration indication (TCI) state provided by an embodiment of the present disclosure. The apparatus 800 for indicating the transmission configuration indication (TCI) state may be a network device, or a terminal device, or a chip, a chip system, or a processor that supports the network device to implement the above method, or a chip, a chip system, or a processor that supports the terminal device to implement the above method. The apparatus may be used to implement the method described in the above method embodiments, and the details can be referred to in the description in the above method embodiments.

The apparatus 800 for indicating the transmission configuration indication (TCI) state may include one or more processors 801. The processor 801 may be a general-purpose processor or a special-purpose processor, etc. For example, it may be a baseband processor or a central processing unit. The baseband processor may be configured to process a communication protocol as well as communication data, and the central processing unit may be configured to control the apparatus for indicating the transmission configuration indication (TCI) state (e.g., a base station, a baseband chip, a terminal device, a terminal device chip, a DU or a CU, etc.), execute a computer program, and process data of the computer program.

Optionally, the apparatus 800 for indicating the transmission configuration indication (TCI) state may further include one or more memories 802, on which a computer program 803 may be stored, and the processor 801 executes the computer program 803, so that the apparatus 800 for indicating the transmission configuration indication (TCI) state performs the method described in the above method embodiments. The computer program 703 may be solidified in the processor 801, in which case the processor 801 may be implemented by hardware.

Optionally, data may also be stored in the memory 802. The apparatus 700 for indicating the transmission configuration indication (TCI) state and the memory 802 may be provided separately or integrated together.

Optionally, the apparatus 800 for indicating the transmission configuration indication (TCI) state may further include a transceiver 805 and an antenna 806. The transceiver 805 may be referred to as a transceiving unit, a transceiver, or a transceiver circuit, etc., is used to implement the transceiving function. The transceiver 705 may include a receiver and a transmitter, the receiver may be referred to as a receiver or a receiving circuit, etc., and is used to implement the receiving function; the transmitter may be referred to as a transmitter or a transmitting circuit, etc., and is used to implement the transmitting function.

Optionally, the apparatus 800 for indicating the transmission configuration indication (TCI) state may further include one or more interface circuits 807. The interface circuit 807 is used to receive code instructions and transmit them to the processor 801. The processor 801 executes the code instructions to enable the apparatus 800 for indicating the transmission configuration indication (TCI) state to perform the method described in the above method embodiments.

The apparatus 800 for indicating the transmission configuration indication (TCI) state is a terminal device, and the transceiver 805 is configured to execute the step 101 in FIG. 1 and the steps 201 to 202 in FIG. 2.

The apparatus 800 for indicating the transmission configuration indication (TCI) state is a network device, and the transceiver 805 is configured to execute the step 401 in FIG. 4 and the step 501 in FIG. 5.

In an implementation, the processor 801 may include a transceiver for implementing the receiving and transmitting functions. The transceiver may be, for example, a transceiver circuit, an interface, or an interface circuit. The transceiver circuit, interface, or interface circuit for implementing the receiving and transmitting functions may be separated or may be integrated together. The transceiver circuit, interface, or interface circuit described above may be used for code/data reading and writing, or may be used for signal transmission or delivery.

In an implementation, the apparatus 800 for indicating the transmission configuration indication TCI state may include circuits. The circuits may implement the sending, receiving or communicating function in the preceding method embodiments. The processor and transceiver described in the present disclosure may be implemented on integrated circuits (ICs), analog ICs, radio frequency integrated circuits (RFICs), mixed signal ICs, application specific integrated circuits (ASICs), printed circuit boards (PCBs), and electronic devices. The processor and transceiver may also be produced using various IC process technologies, such as complementary metal oxide semiconductor (CMOS), nMetal-oxide-semiconductor (NMOS), positive channel metal oxide semiconductor (PMOS), bipolar junction transistor (BJT), bipolar CMOS (BiCMOS), silicon-germanium (SiGe), gallium arsenide (GaAs) and so on.

The apparatus for indicating the transmission configuration indication (TCI) state described in the above embodiments may be a network device or a terminal device, but the scope of the apparatus for indicating the transmission configuration indication (TCI) state described in the present disclosure is not limited thereto, and the structure of the apparatus for indicating the transmission configuration indication (TCI) state may not be limited by FIG. 6-FIG. 7. The apparatus for indicating the transmission configuration indication (TCI) state may be an independent device or may be part of a larger device. For example, the apparatus for indicating the transmission configuration indication (TCI) state may be:
(1) a stand-alone IC, chip, chip system or subsystem;
(2) a collection of ICs including one or more ICs, optionally, the collection of ICs may also include storage components for storing data and computer programs;
(3) an ASIC, such as a modem;
(4) modules that may be embedded within other devices;
(5) receivers, terminals, smart terminals, cellular phones, wireless devices, handheld machines, mobile units, in-vehicle devices, network devices, cloud devices, artificial intelligence devices, and the like; and
(6) others.

For the case where the apparatus for indicating the transmission configuration indication (TCI) state may be a chip or a chip system, with reference to the structural diagram of the chip shown in FIG. 9. The chip shown in FIG. 9 includes a processor 901 and an interface 902. There may may be one or more processors 901, and there may be a plurality of the interfaces 902.

For the case where the chip is used to implement the functions of the network device in the embodiments of the present disclosure.

The interface 902 is used for code instructions and transmission to the processor.

The processor 901 is configured to run code instructions to execute the method shown in FIGS. 1 to 2.

For the case where the chip is used to implement the functions of the terminal device in the embodiments of the present disclosure.

The interface 902 is configured to receive code instructions and transmit them to the processor.

The processor 901 is configured to run code instructions to execute the method shown in FIGS. 4 to 5.

Optionally, the chip further includes a memory 903 used to store necessary computer programs and data.

It is understandable by those skilled in the art that various illustrative logical blocks and steps listed in the embodiments of the disclosure may be implemented by electronic hardware, computer software, or a combination of both. Whether such function is implemented by hardware or software depends on the particular application and the design requirements of the entire system. Those skilled in the art may, for each particular application, use various methods to implement the described function, but such implementation should not be construed as being beyond the scope of protection of the embodiments of the disclosure.

An embodiment of the present disclosure further provides a communication system, which includes the apparatus for indicating the transmission configuration indication (TCI) state as a terminal device and the apparatus for indicating the transmission configuration indication (TCI) state as a network device in the embodiments of FIGS. 6 and 7, or the system includes the apparatus for indicating the transmission configuration indication (TCI) state as a terminal device and the apparatus for indicating the transmission configuration indication (TCI) state as a network device in the embodiment of FIG. 8.

The present disclosure also provides a readable storage medium having instructions stored thereon. When the instructions are executed by a computer, the function of any of the method embodiments described above is implemented.

The present disclosure also provides a computer program product. When the computer program product is executed by a computer, the function of any of the method embodiments described above is implemented.

The above embodiments may be implemented in whole or in part by software, hardware, firmware, or any combination thereof. When implemented using software, it may be implemented, in whole or in part, in the form of a computer program product. The computer program product includes one or more computer programs. When loading and executing the computer program on the computer, all or part of processes or functions described in the embodiments of the disclosure is implemented. The computer may be a general-purpose computer, a dedicated computer, a computer network, or other programmable devices. The computer program may be stored in a computer-readable storage medium or transmitted from one computer-readable storage medium to another computer-readable storage medium. For example, the computer program may be transmitted from one web site, computer, server, or data center to another web site, computer, server, or data center, in a wired manner (e.g., by using coaxial cables, fiber optics, or digital subscriber lines (DSLs) or wirelessly (e.g., by using infrared wave, wireless wave, or microwave). The computer-readable storage medium may be any usable medium to which the computer has access or a data storage device integrated by one or more usable mediums such as a server and a data center. The usable medium may be a magnetic medium (e.g., floppy disk, hard disk, and tape), an optical medium (e.g., a high-density digital video disc (DVD)), or a semiconductor medium (e.g., a solid state disk (SSD)), etc.

Those skilled in the art understand that “first”, “second”, and other various numerical numbers involved in the disclosure are only described for the convenience of differentiation, and are not used to limit the scope of the embodiments of the disclosure, or indicate the order of precedence.

The term “at least one” in the disclosure may also be described as one or more, and the term “multiple” may be two, three, four, or more, which is not limited in the disclosure. In the embodiments of the disclosure, for a type of technical features, “first”, “second”, and “third”, and “A”, “B”, “C” and “D” are used to distinguish different technical features of the type, the technical features described using the “first”, “second”, and “third”, and “A”, “B”, “C” and “D” do not indicate any order of precedence or magnitude.

The correspondences shown in the tables in the present disclosure may be configured or may be predefined. The values of information in the tables are merely examples and may be configured to other values, which are not limited by the present disclosure. In configuring the correspondence between the information and the parameter, it is not necessarily required that all the correspondences illustrated in the tables must be configured. For example, the correspondences illustrated in certain rows in the tables in the present disclosure may not be configured. For another example, the above tables may be adjusted appropriately, such as splitting, combining, and the like. The names of the parameters shown in the titles of the above tables may be other names that may be understood by the communication apparatus, and the values or representations of the parameters may be other values or representations that may be understood by the communication apparatus. Each of the above tables may also be implemented with other data structures, such as, arrays, queues, containers, stacks, linear tables, pointers, chained lists, trees, graphs, structures, classes, heaps, and Hash tables.

The term “predefine” in this disclosure may be understood as define, define in advance, store, pre-store, pre-negotiate, pre-configure, solidify, or pre-bake.

Those skilled in the art may realize that the units and algorithmic steps of the various examples described in combination with the embodiments disclosed herein are capable of being implemented in the form of electronic hardware, or a combination of computer software and electronic hardware. Whether these functions are performed in the form of hardware or software depends on the specific application and design constraints of the technical solution. Those skilled in the art may use different methods to implement the described functions for each particular application, but such implementations should not be considered as beyond the scope of the present disclosure.

It is clearly understood by those skilled in the field to which it belongs that, for the convenience and brevity of description, the specific working processes of the systems, apparatuses, and units described above may be referred to the corresponding processes in the preceding method embodiments, and will not be repeated herein.

It should be understood that various forms of processes shown above can be used, and steps can be reordered, added, or deleted. For example, the steps described in the embodiments of the present disclosure can be executed in parallel, sequentially, or in a different order. As long as the desired results of the technical solutions disclosed in the present disclosure can be achieved, no limitations are imposed herein.

The above specific implementations do not constitute a limitation on the protection scope of the present disclosure. It should be understood by those skilled in the art that various modifications, combinations, sub-combinations and substitutions can be made according to design requirements and other factors. Any modification, equivalent substitution and improvement made within the spirit and principle of the present disclosure should be included in the protection scope of the present disclosure.

1. A method for indicating a transmission configuration indication (TCI) state performed by a terminal device, the method comprising:
receiving downlink control information (DCI) sent by a network device, wherein the DCI comprises at least one of a first information field or a second information field, the first information field is used to map a transmission configuration indication (TCI) state group activated by the terminal device, and the second information field is used to indicate whether to enable at least one TCI state comprised in the TCI state group corresponding to the first information field.

2. The method according to claim 1, wherein the method further comprises:
receiving a media access control control element (MAC CE) sent by the network device, wherein the MAC CE is used to indicate at least one TCI state group activated by the terminal device and at least one TCI state comprised in each TCI state group.

3. The method according to claim 2, wherein the first information field comprises at least one code point, and each of the at least one code points corresponds to one TCI state group indicated by the MAC CE.

4. The method according to claim 3, wherein the number of the at least one code points comprised in the first information field is the same as a maximum number of the at least one TCI state group activated as indicated by the MAC CE.

5. The method according to claim 1, wherein the second information field comprises at least one first indication information, and the first indication information is used to indicate whether a TCI state corresponding to the first indication information is enabled.

6. The method according to claim 5, wherein the number of the at least one first indication information comprised in the second information field is the same as a maximum number of the at least one TCI state comprised in the TCI state group.

7. The method according to claim 1, wherein the method further comprises:
receiving a first signaling sent by the network device, wherein the first signaling is used to indicate whether the DCI comprises the second information field.

8. The method according to claim 1, wherein at least one of the first information field or the second information field occupies a reserved information field of the DCI; or
at least one of the first information field or the second information field occupies a newly added information field of the DCI.

9. A method for indicating a transmission configuration indication (TCI) state performed by a network device, the method comprising:
sending downlink control information (DCI) to a terminal device, wherein the DCI comprises at least one of a first information field or a second information field, the first information field is used to map a transmission configuration indication (TCI) state group activated by the terminal device, and the second information field is used to indicate whether to enable at least one TCI state comprised in the TCI state group corresponding to the first information field.

10. The method according to claim 9, wherein the method further comprises:
sending a media access control control element (MAC CE) to the terminal device, wherein the MAC CE is used to indicate at least one TCI state group activated by the terminal device and at least one TCI state comprised in each TCI state group.

11. The method according to claim 10, wherein the first information field comprises at least one code point, and each of the at least one code points corresponds to one TCI state group indicated by the MAC CE.

12. The method according to claim 11, wherein the number of the at least one code point comprised in the first information field is the same as a maximum number of the at least one TCI state group activated as indicated by the MAC CE.

13. The method according to claim 9, wherein the second information field comprises at least one first indication information, and the first indication information is used to indicate whether a TCI state corresponding to the first indication information is enabled.

14. The method according to claim 13, wherein the number of the at least one first indication information comprised in the second information field is the same as a maximum number of the at least one TCI state comprised in the TCI state group.

15. The method according to claim 9, wherein the method further comprises:
sending a first signaling to the terminal device, wherein the first signaling is used to indicate whether the DCI comprises the second information field.

16. The method according to claim 9, wherein at least one of the first information field or the second information field occupies a reserved information field of the DCI; or
at least one of the first information field or the second information field occupies a newly added information field of the DCI.

17. An apparatus for indicating a transmission configuration indication (TCI) state, the apparatus comprising:
a processor; and
a memory, that stores a computer program, and
wherein the computer program when executed by the processor causes the apparatus to:
receive downlink control information (DCI) sent by a network device, wherein the DCI comprises at least one of a first information field or a second information field, the first information field is used to map a transmission configuration indication (TCI) state group activated by the apparatus, and the second information field is used to indicate whether to enable at least one TCI state comprised in the TCI state group corresponding to the first information field.

18. An apparatus for indicating a transmission configuration indication (TCI) state, comprising:
a processor; and
a memory, that stores a computer program, and
the-computer program when executed by the processor causes the apparatus to act as the network device and perform the method according to claim 9.

19. (canceled)

20. (canceled)

21. A non-transitory computer-readable storage medium storing instructions, which, when executed by a processor of the terminal device, cause the terminal device to perform the method according to claim 1.

22. (canceled)

23. A non-transitory computer-readable storage medium, storing instructions, which, when executed by a processor of the network device, cause the network device to perform the method according to claim 9.
